(19) United States
(12) Patent Application Publication
(10) Pub. No.: US 2007/0139310 A1
(43) Pub. Date: Jun. 21, 2007

(54) Electron emission display device and driving method thereof

(76) Inventors: Mun Seok Kang, Anyang-si (KR); Chul Ho Lee, Cheonan-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/586,311

(22) Filed: Oct. 24, 2006

(30) Foreign Application Priority Data
Dec. 6, 2005 (KR) 10-2005-0118095

(51) Int. Cl. G09G 3/30

(52) U.S. Cl. 345/76

(57) ABSTRACT

An electron emission display device and a driving method thereof are disclosed. The device and method limit a brightness thereof in order to reduce power consumption, and adjust a gamma compensation according to a limit width of the brightness to reduce a gamma compensation deviation, causing an increase in a quality of an image. In a pixel portion, a brightness is controlled corresponding to applied voltages of a first electrode and a second electrode and an emission time. An image signal summing section receives and sums image signals by frame periods. A gamma selector selects a gamma based on an output signal of the image signal summing section and compensates for the image signals. A data driver converts the compensated image signals to generate a data signal, and transfers the data signal to the first electrode. A scan driver generates and transfers a scan signal to the second electrode.

### CROSS-REFERENCE TO RELATED APPLICATIONS

This application claims the benefit of Korean Patent Application No. 10-2005-0118095, filed on Dec. 6, 2005, in the Korean Intellectual Property Office, the disclosure of which is incorporated herein by reference.

### BACKGROUND OF THE INVENTION

1. Field of the Invention

The present invention relates to an electron emission display device and a driving method thereof. More particularly, the present invention relates to an electron emission display device and a driving method thereof, which provide gamma compensation.

2. Description of the Related Technology

Lightweight and thin flat panel displays have been used as either a display device of a portable information terminal such as a personal computer, a portable telephone, and a PDA or a monitor of all kinds of information devices. A liquid crystal display (LCD) using a liquid crystal panel, an organic light emitting display using an organic light emitting diode, and a PDP using a plasma panel have been known as examples of such flat panel displays.

Flat panel displays are classified into an active matrix type and a passive matrix type according to its construction, and a memory drive type and a non-memory drive type according to a light emitting theory. In general, the active matrix type may correspond to the memory drive type, and the passive matrix type may correspond to the non-memory drive type. The active matrix type and memory drive type displays emit light in frames. In contrast to this, the passive matrix type and non-memory drive type displays emit light in lines.

Among flat panel displays, TFT-LCD (Thin Film Transistor Liquid Crystal Display) is an active matrix type device, and a newly developed organic light emitting diode (OLED) is also an active matrix type device. On the other hand, an Electron Emission Display is a passive matrix type device. An Electron Emission Display is a non-memory drive type device, and uses a line scan type that emits light only when a selected line among horizontal lines is selected while sequentially selecting the horizontal lines. That is, an Electron Emission Display has a constant duty ratio.

Electron emission devices include a heat emission type and a cold emission type using a heat cathode and a cold cathode, respectively, as an electron source. The cold emission type device includes a field emitter array (FEA) type, a surface conduction emitter (SCE) type, a metal-insulator-metal (MIM) type, a metal-insulator-semiconductor (MIS) type, and a ballistic electron surface emitter (BSE) type.

An FEA type electron emission device emits electrons due to an electric field difference in a vacuum by using materials having a low work function or a high β function as an electron emitting source. An FEA type electron emission device using a tip structure having a shape-pointed front end, carbon system materials, or nano materials as an electron emitting source has been developed.

In an SCE type electron emission device, a conductive thin film is formed on a substrate between two electrons facing each other. Incurring a fine crack in the conductive thin film forms an electron emitting portion. The SCE type electron emission device applies a voltage to an electrode to flow an electric current through a surface of the conductive thin film, with the result that electrons are emitted from an electron emitting portion being a minute gap.

In an MIM type electron emission device, an electron emitting portions with an MIM structure is formed. When a voltage is applied to two metals with an insulator interposed therebetween, electrons are moved and accelerated from a metal having a higher electron potential to a metal having a lower electron potential.

In an MIS type electron emission device, an electron emitting portion with an MIS structure is formed. When a voltage is applied to a metal and a semiconductor with an insulator interposed therebetween, electrons are moved and accelerated from a semiconductor having a higher electron potential to a metal having a lower electron potential.

In a BSE type electron emission device, an electron supply layer comprising a metal or a semiconductor is formed on an ohmic electrode using a following principle. The principle is that electrons travel without dispersion when a size of a semiconductor is reduced to a size range less than a mean free path of an electron in the semiconductor. An insulation layer and a metal thin film are formed on the electron supply layer. By applying a power source to the ohmic electrode and the metal thin film, electrons are emitted.

Like a CRT, the electron emission device has advantages in that it operates by an emission of a cathode electrode line (self-light source, high efficiency, high brightness, wide brightness region, natural color, high color purity, and wide view angle). In addition, operation speed range and an operation temperature range are great. Accordingly, the electron emission device is applicable to various fields and has been actively studied.

FIG. 1 is a block diagram showing an electron emission display device. With reference to FIG. 1, the electron emission display device includes a pixel portion 10, a data driver 20, a scan driver 30, and a timing controller 40.

The pixel portion 10 includes pixels 11 provided at intersections between the cathode electrodes C1, C2, . . . , Cn and the gate electrodes G1, G2, . . . , Gn. Each of the pixels 10 includes an electron emission portion. In the electron emission portion, electrons emitted from the cathode electrode collide with the anode electrode that allows a fluorescent substance to emit light in order to display a gradation of an image. The gradation of an image is varied according to a value of a digital image signal. In order to adjust the gradation of an image, a pulse width modulation (PWM) or a pulse amplitude modulation may be used.

The data driver 20 generates a data signal using an image signal. The data driver 20 is associated with the cathode electrodes C1, C2, . . . , Cn, and transmits the data signal to the pixel portion 10, so that the pixel portion 10 emits light corresponding to the data signal.

The scan driver 30 is connected to the gate electrodes G1, G2, . . . , Gn. The scan driver 30 generates and transmits a scan signal to the pixel portion 10 so that the pixel portion 10 sequentially emits light every time period in horizontal lines by a line scan method to display an entire screen. This configuration reduces the cost of the circuit and power consumption.

The timing controller 40 controls the data driver 20 and the scan driver 30 to generate the data signal and the scan signal, respectively.

In the electron emission display device, when the number of pixels emitting light of a higher brightness is large, an electric current flowing through the pixel portion 10 becomes great, thereby increasing power consumption and shortening the life of the electron emission portion.

### SUMMARY OF CERTAIN INVENTIVE ASPECTS

One aspect of the invention provides a method of driving an electron emission display device. The method comprises: providing an array of pixels comprising a first pixel configured to emit light when a pixel voltage is applied thereto; providing an image signal of a frame to be displayed by the array of pixels; calculating overall luminance of the frame to be generated by the array based on the image signal of the frame; adjusting the pixel voltage of the first pixel based on the calculated overall luminance of the frame; adjusting the period of time during which the first pixel is to be turned on based on the adjusted pixel voltage; and applying the adjusted pixel voltage to the first pixel during the adjusted period of time.

The image signal may comprise a gradation value indicative of luminance of light to be emitted by the first pixel relative to luminance of light to be emitted by other pixels. Adjusting the period of time may comprise maintaining a gradation-to-luminance ratio substantially constant without regard to the adjusted pixel voltage. Adjusting the period of time is based on a stored lookup table comprising various values of the adjusted period of time, and each value of the adjusted time may be provided for each gradation level and for each adjusted pixel voltage. The lookup table may comprise data for compensating non-linearity between the pixel voltage and the luminance of light emitted by the first pixel.

The pixel voltage may be adjusted such that the higher the calculated overall luminance is, the smaller the pixel voltage is. Adjusting the pixel voltage may comprise: selecting a value of pixel voltage corresponding to the calculated overall luminance from a plurality of predetermined values of the pixel voltage, each of which has a corresponding luminance. Adjusting the period of time may comprise: selecting a modulation signal based on the selected value of the pixel voltage from a plurality of modulation signals, each of which has a corresponding luminance.

The image signal may comprise a gradation value indicative of luminance of light to be emitted by the first pixel relative to luminance of light to be emitted by other pixels, and selecting the modulation signal may be further based on the gradation value. Adjusting the period of time may further comprise: generating a clock signal; and applying the selected modulation signal to the clock signal.

Another aspect of the invention provides an electron emission display device programmed to conduct the method described above.

Yet another aspect of the invention provides an electron emission display device. The device comprises: an array of pixels comprising a first pixel configured to emit light when a pixel voltage is applied thereto; a processor configured to calculate overall luminance of a frame based on an image signal for the frame; a voltage generator configured to adjust a pixel voltage of the first pixel based on the calculated overall luminance of the frame; a data driver configured to provide a data signal to the array of pixels, the data driver being configured to adjust the period of time during which the first pixel is to be turned on based on the adjusted pixel voltage, the data driver being further configured to apply the adjusted pixel voltage to the first pixel during the adjusted period of time; and a scan driver configured to provide a scan signal to the array of pixels.

The image signal may comprise a gradation value indicative of luminance of light to be emitted by the first pixel relative to luminance of light to be emitted by other pixels. The data driver may be configured to maintain a gradation-to-luminance ratio substantially constant without regard to the adjusted the pixel voltage. The data driver may comprise a lookup table comprising various values of the adjusted period of time, wherein each value of the adjusted time is provided for each gradation level and for each adjusted pixel voltage, and wherein the data driver is configured to adjust the period of time based on the lookup table. The lookup table may comprise data for compensating non-linearity between the pixel voltage and the luminance of light emitted by the first pixel.

The voltage generator may be configured to adjust the pixel voltage as the higher the calculated overall luminance is, the smaller the pixel voltage is. The voltage generator may comprise a lookup table comprising a plurality of predetermined values of the pixel voltage, each of which has a corresponding to luminance, and the voltage generator may be configured to select one of the predetermined values of the pixel voltage based on the calculated overall luminance.

The data driver may comprise a lookup table comprising a plurality of modulation signals, each of which has a corresponding value of the pixel voltage, and the data driver may be configured to select one of the plurality of modulation signals based on the selected value of pixel voltage. The data driver may further comprise a clock generator for generating a clock signal, and the data driver is configured to apply the selected one of the modulation signals to the clock signal.

Another aspect of the invention provides an electron emission display device and a driving method thereof, which limit a brightness thereof in order to reduce power consumption, and adjust gamma compensation according to a limit width of the brightness to reduce a gamma compensation deviation, causing an increase in a quality of an image.

Another aspect of the invention provides an electron emission display device comprising: a pixel portion in which a brightness is controlled corresponding to applied voltages of a first electrode and a second electrode and an emission time; an image signal summing section for receiving and summing image signals by frame periods; a gamma selector for selecting a gamma based on an output signal of the image signal summing section and for compensating for the image signals; a data driver for converting the compensated image signals to generate a data signal, and for transferring the data signal to the first electrode; and a scan driver for generating and transferring a scan signal to the second electrode.

Another aspect of the invention provides a method for driving an electron emission display device that displays an image at a time corresponding to a data signal, comprising the steps of: (i) receiving image signals for a predetermined time to obtain a sum of the image signals; (ii) determining a voltage difference between a first electrode and a second electrode based on the sum of the image signals; (iii) changing a pulse width of the data signal corresponding to the image signals based on a plurality of addresses stored corresponding to the voltage difference between a first electrode and a second electrode in order to vary a gradation and a brightness rate of a pixel corresponding to the voltage difference between a first electrode and a second electrode.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing an electron emission display;

FIG. 2 is a block diagram showing an electron emission display according to an embodiment;

FIG. 3 is a graph showing a relationship between a brightness and a gradation according to an embodiment;

FIG. 4 is a block diagram showing an embodiment of a voltage controller of the electron emission display of FIG. 2;

FIG. 5 is a block diagram showing an embodiment of a gamma compensator of the electron emission of FIG. 2; and

FIG. 6 is a timing chart showing a pulse of a data signal generated by the emission time adjusting section of FIG. 2.

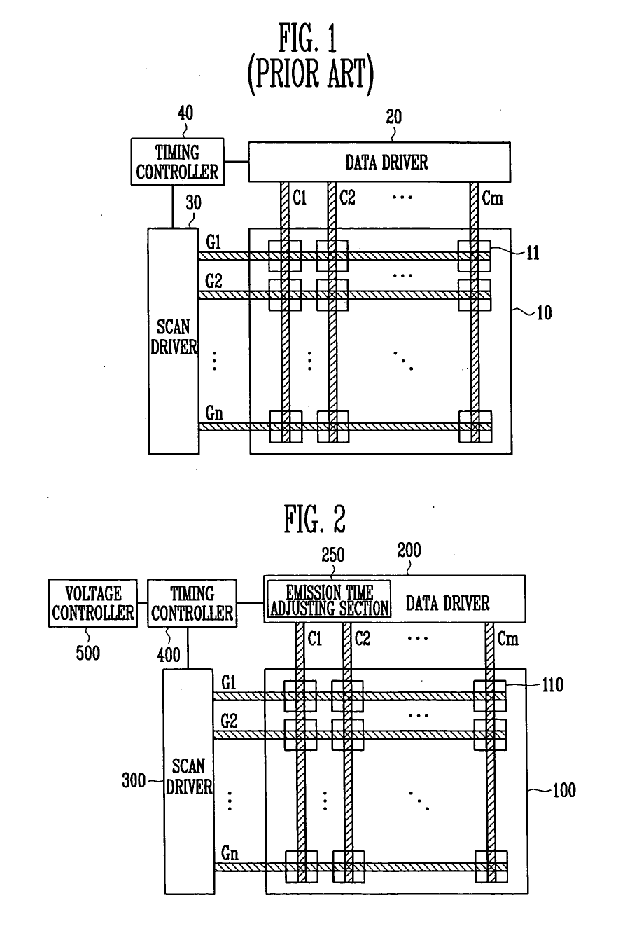

### DETAILED DESCRIPTION OF CERTAIN INVENTIVE EMBODIMENTS

Hereinafter, embodiments will be described with reference to the accompanying drawings. Here, when one element is connected to another element, one element may be either directly connected to another element or indirectly connected to another element via another element. Further, irrelevant elements are omitted for clarity. Also, like reference numerals indicate identical or functionally similar elements.

FIG. 2 is a block diagram showing an electron emission display according to an embodiment. FIG. 3 is a graph showing a relationship between a brightness and a gradation according to an embodiment. With reference to FIG. 2 and FIG. 3, the electron emission display device includes a pixel portion 100, a data driver 200, a scan driver 300, a timing controller 400, and a voltage controller 500.

The pixel portion 100 includes pixels 101 in which a plurality of cathode electrodes C1, C2, . . . , Cn are arranged in a row direction, a plurality of gate electrodes G1, G2, . . . , Gn are arranged in a column direction, and electron emission sections provided at respective intersections between the cathode electrodes C1, C2, . . . , Cn and the gate electrodes G1, G2, . . . , Gn. Alternatively, the cathode electrodes C1, C2, . . . , Cn and the gate electrodes G1, G2, . . . , Gn may be arranged in column and row directions, respectively. Hereinafter, it is assumed that the cathode electrodes C1, C2, . . . , Cn are arranged in a row direction, and the gate electrodes G1, G2, . . . , Gn are arranged in a column direction.

When the number of pixels 101 emitting light of a high brightness is large, the pixel portion 100 is configured to lower a voltage difference between the gate electrodes G1, G2, . . . , Gn and the cathode electrodes C1, C2, . . . , Cn, so as to lower the brightness of each pixel. When the number of pixels 101 emitting light of a high brightness is small, the pixel portion 100 is configured to increase the voltage difference between the gate electrodes G1, G2, . . . , Gn and the cathode electrodes C1, C2, . . . , Cn, so as to increase the brightness of each pixel. When the number of pixels 101 emitting light of a high brightness is large, the brightness of each pixel is lowered, thereby lowering power consumption. When the number of pixels 101 emitting light of a high brightness is small, a brightness limit width of a pixel emitting light of a high brightness is small. Accordingly, a brightness difference between a pixel emitting light of a higher brightness and a pixel emitting light of a lower brightness may be further increased to enhance the contrast.

With reference to FIG. 3, if voltages (for example, voltages Vcg1 and Vcg2) between the gate electrodes G1, G2, . . . , Gn and the cathode electrodes C1, C2, . . . , Cn are different, the displayed brightnesses are also different even at the same gradation data input. The difference in the brightness may adversely affect the quality of the displayed image. Accordingly, the emission time of each pixel is adjusted so as to have the same gradation-to-brightness ratio for different voltages.

The data driver 200 includes an emission time adjusting section 250. The data driver 200 receives and converts an image signal into a data signal by means of the emission time adjusting section 250. Then, the data driver 200 is associated with the cathode electrodes C1, C2, . . . , Cn and transmits the data signal thereto. The data driver 200 determines emission times of pixels 101 formed at intersections between the cathode electrodes C1, C2, . . . , Cn and the gate electrodes G1, G2, . . . , Gn corresponding to the data signal.

The emission time adjusting section 250 adjusts the emission times of the pixels 101 according to a limit range of a brightness which has been controlled by the voltage controller 500. That is, the emission time adjusting section 250 adjusts the emission times of the pixels 101 corresponding to voltage differences between the cathode electrodes C1, C2, . . . , Cn and the gate electrodes G1, G2, . . . , Gn to have the same gradation-to-brightness ratio. Accordingly, although the voltage differences occur between the cathode electrodes C1, C2, . . . , Cn and the gate electrodes G1, G2, . . . , Gn, the same brightness variation is obtained, thus providing a high quality image.

The scan driver 300 is connected to the gate electrodes G1, G2, . . . , Gn, and selects one from the gate electrodes G1, G2, . . . , Gn. The scan driver 300 transfers a scan signal to pixels 101 connected to the gate electrodes G1, G2, . . . , Gn.

The timing controller 400 controls the data driver 200 and the scan driver 300 to generate a data signal and a scan signal, respectively.

The voltage controller 500 controls a difference between a voltage of the cathode electrodes C1, C2, . . . , Cn and a voltage of the gate electrodes G1, G2, . . . , Gn to limit the brightness of the pixel portion 100. The higher the brightness of the pixel portion 100 is, the greater the voltage controller 500 limits the brightness. Accordingly, when the pixel portion 100 emits light of a higher brightness, a limit range of the brightness is increased. In contrast to this, when the pixel portion 100 emits light of a lower brightness, a limit range of the brightness is reduced. Here, by adjusting the voltage of the gate electrodes G1, G2, . . . , Gn, the difference between the voltage of the cathode electrodes C1, C2, . . . , Cn and the voltage of the gate electrodes G1, G2, . . . , Gn may be adjusted.

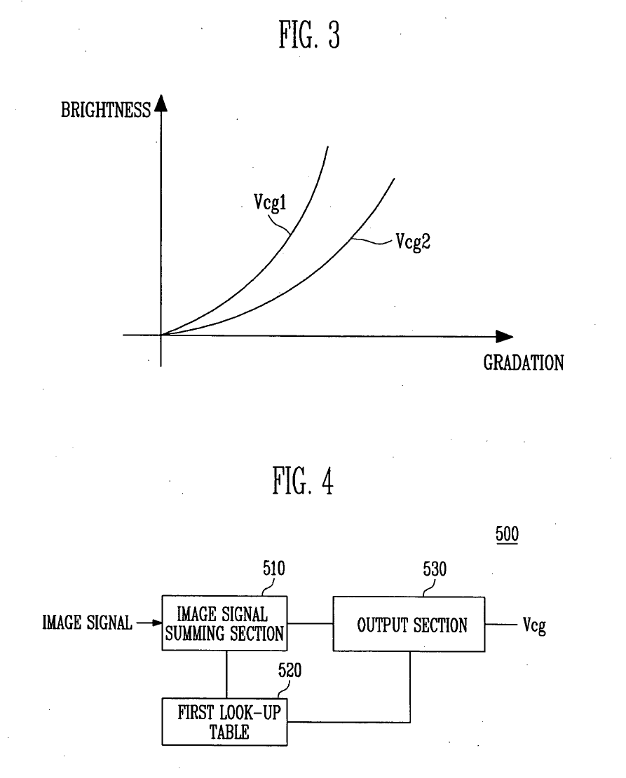

FIG. 4 is a block diagram showing an example of a voltage controller of the electron emission display device shown in FIG. 2. Referring to FIG. 4, the voltage controller 500 includes an image signal summing section 510, a first look-up table 520, and an output section 530.

The image signal summing section 510 sums image signals inputted during one frame period to determine the brightness of the pixel portion 100 during the one frame period. When the sum of the image signals is great, the image signal summing section 510 determines that the brightness of the pixel portion 100 is high. When the sum of the image signals is small, the image signal summing section 510 determines that the brightness of the pixel portion 100 is low.

The first look-up table 520 stores a brightness limit width corresponding to the sum of the image signals. A brightness limit width is set for a sum of respective image signal data. When the sum of the image signals is large, the brightness limit width is set to be wide. In contrast to this, when the sum of the image signals is small, the brightness limit width is set to be narrow.

The voltage output section 530 adjusts the voltage difference between a cathode electrode and a gate electrode corresponding to the brightness limit width stored in the first look-up table 520. When the data signal is transferred to the voltage output section 530, the voltage output section 530 adjusts a voltage of the gate electrode in order to adjust the voltage difference between the cathode electrode and the gate electrode.

When the difference between the voltage of the cathode electrodes C1, C2, . . . , Cn and the voltage of the gate electrodes G1, G2, . . . , Gn is small, the amount of electrons emitted from the electron emission section becomes small to express a low brightness. In contrast to this, when the difference of the voltage of the cathode electrodes C1, C2, . . . , Cn and the voltage of the gate electrodes G1, G2, . . . , Gn is large, the amount of electrons emitted from the electron emission section becomes large to express a high brightness. Due to the difference between the voltage of the cathode electrodes C1, C2, . . . , Cn and the voltage of the gate electrodes G1, G2, . . . , Gn, different brightnesses are expressed at the same gradation value.

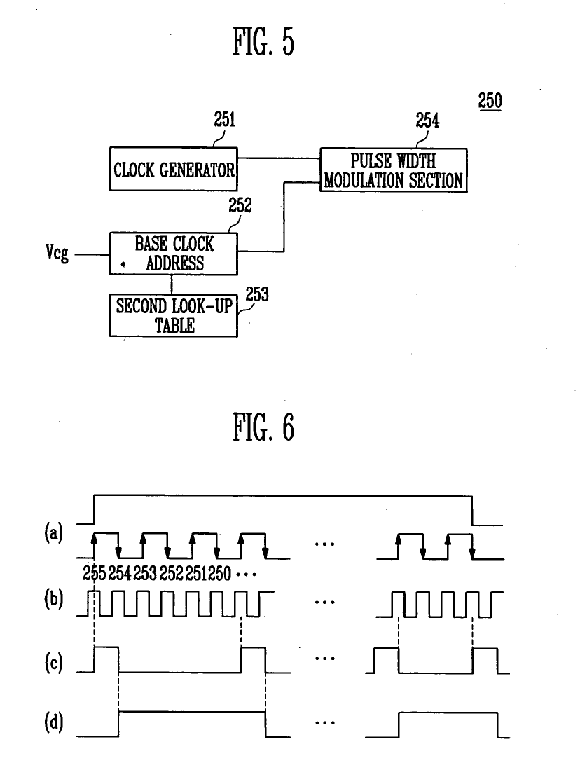

FIG. 5 is a block diagram showing an example of a gamma compensator of the electron emission display shown in FIG. 2. With reference to FIG. 5, the emission time adjusting section 250 includes a clock generator 251, a base clock address section 252, a second look-up table 253, and a pulse width modulation section 254.

The clock generator 251 generates at least the same number of clocks as that of gradations during one horizontal period. For example, when 256 gradations are expressed, the clock generator 251 generates at least 256 clocks during one horizontal period.

The base clock address section 252 determines the voltage of the gate electrode and the voltage of the cathode electrode, and generates an address signal corresponding to the address stored in the second look-up table 253.

The second look-up table 253 stores an address corresponding to a voltage difference between the gate and cathode electrodes and transmits the address to the base clock address section 252. The following table 1 shows an example of the second look-up table 253.

TABLE 1

| Base clock | | | | | | | |
|---|---|---|---|---|---|---|---|
| address | 0 | 1 | 2 | 3 | . . . | 1022 | 1023 |
| Vcg1 | 1 | 0 | 0 | 1 | . . . | 0 | 1 |
| Vcg2 | 1 | 0 | 1 | 0 | . . . | 1 | 1 |
| Vcg3 | 1 | 0 | 1 | 0 | . . . | 1 | 1 |
| Vcg4 | 1 | 1 | 0 | 1 | . . . | 0 | 1 |
| . . . | . . . | . . . | . . . | . . . | . . . | . . . | . . . |
| Vcg256 | 1 | 1 | 1 | 1 | . . . | 0 | 1 |

Here, Vcg represents a voltage difference between the cathode electrode and the gate electrode. The voltage difference between the cathode electrode and the gate electrode is divided into 256 stages. The base clock address has values from 0 to 1023. Brightness variations of 1024 stages may be designated corresponding to a variation of a voltage difference between the gate electrode and the cathode electrode.

The pulse width modulation section 254 adjusts a pulse width of a data signal based on the clock generated by the clock generator 251 and the base clock address 252. The pulse width of the data signal adjusts the emission time of a pixel. Accordingly, although the same image signal is transmitted, a brightness according to an emission time is differently expressed, with the result that a brightness by gradations is differently expressed. While limiting a brightness due to the voltage difference between the cathode electrodes C1, C2, . . . , Cn and the gate electrodes G1, G2, . . . , Gn, a pulse width of the data signal varies to change a ratio of gradation to brightness. As the gradation increases, the brightness increases at a different ratio. This causes a brightness corresponding to an actual input image signal to be differently expressed. That is, gamma compensation can be obtained without compensation of the image signal.

In a case that the number of the base clock address is “1,” when a previous signal is at a high level, a pulse of a data outputted from the pulse width modulation section 254 becomes low. When the previous signal is at a low level, a pulse of a data outputted from the pulse width modulation section 254 becomes high. In a case that the number of the base clock address is “0,” when a previous signal is at a low level, the pulse width modulation section 254 outputs a low pulse. When the previous signal is at a high level, the pulse width modulation section 254 outputs a high pulse. Consequently, the pulse width modulation section 254 may adjust a pulse width of the data signal corresponding to a voltage difference between a gate electrode and a cathode electrode.

FIG. 6 is a timing chart showing a pulse of a data signal generated by the emission time adjusting section shown in FIG. 5. As shown in FIG. 6, reference numeral “a” denotes a counter signal, which is counted within a predetermined time. Reference numeral “b” denotes clocks generated by a clock generator 251, and the number of clocks is 1024. Reference numeral “c” denotes an address signal corresponding to an address to form a pulse of the data signal in the pulse width modulation section 154. Reference numeral “d” denotes a pulse of the data signal outputted from the pulse width modulation section 254.

In the counter signal, a plurality of clocks are generated within a predetermined time, and a rising time and a falling time of a clock express one gradation. During one clock generation time, when a pixel emits light, two gradations are expressed.

The clock generator 251 generates clocks CLK. When clocks CLK corresponding to twice the counter signal are generated and an image signal expressing 255 gradations is inputted, 1024 clocks are generated. The number of clocks CLK becomes twice to effectively express the gradation. The number of clocks can be three or four times of the counter signal.

The address signal is a signal that corresponds to a value of a base clock address stored in the second look-up table 253 corresponding to a voltage difference between the cathode electrodes C1, C2, . . . , Cn and the gate electrodes G1, G2, . . . , Gn. The second look-up table 253 stores “1” or “0” signal at respective base addresses corresponding to a voltage difference between the cathode electrodes C1, C2, . . . , Cn and the gate electrodes G1, G2, . . . , Gn, namely, different signals corresponding to the voltage difference between the cathode electrodes C1, C2, . . . , Cn and the gate electrodes G1, G2, . . . , Gn as shown in table 1.

The pulse width modulation section 254 adjusts a pulse width of a data signal according to an address signal. The pulse width modulation section 254 maintains a previous signal when a modulation signal has a low level. When the modulation signal has a high level, the signal is inverted to modulate a pulse width of the data signal. Accordingly, a high period of a pulse of the data signal varies by voltages between the cathode electrodes C1, C2, . . . , Cn and the gate electrodes G1, G2, . . . , Gn, so that respective brightnesses are differently expressed. As shown in FIG. 6, when the modulation signal falls, the pulse is modulated. When the pulse is at a high level, light is emitted.

In an electron emission display device and a driving method thereof according to the present embodiment, a brightness is limited in order to reduce power consumption, and gamma compensation is carried out according to a limit width of the brightness to reduce a gamma compensation deviation, enhancing the quality of an image. Furthermore, power consumption of the electron emission display device is reduced and a life of an electron emission section is improved.

Although a few embodiments have been shown and described, it would be appreciated by those skilled in the art that changes might be made in this embodiment without departing from the principles and spirit of the invention, the scope of which is defined in the claims and their equivalents.

What is claimed is:

1. A method of driving an electron emission display device, the method comprising:
calculating overall luminance of a frame to be displayed by an array of pixel based on a image signal;
adjusting a pixel voltage of a first pixel based on the calculated overall luminance of the frame;
adjusting a period of time during which the first pixel is to be turned on based on the adjusted pixel voltage; and
applying the adjusted pixel voltage to the first pixel during the adjusted period of time.

2. The method of claim 1, wherein the image signal comprises a gradation value indicative of luminance of light to be emitted by the first pixel relative to luminance of light to be emitted by other pixels.

3. The method of claim 1, wherein adjusting the period of time comprises maintaining a gradation-to-luminance ratio substantially constant without regard to the adjusted pixel voltage.

4. The method of claim 1, wherein adjusting the period of time is based on a stored lookup table comprising various values of the adjusted period of time, and wherein each value of the adjusted time is provided for each gradation level and for each adjusted pixel voltage.

5. The method of claim 4, wherein the lookup table comprises data for compensating non-linearity between the pixel voltage and the luminance of light emitted by the first pixel.

6. The method of claim 1, wherein the pixel voltage is adjusted such that the higher the calculated overall luminance is, the smaller the pixel voltage is.

7. The method of claim 1, wherein adjusting the pixel voltage comprises:
selecting a value of pixel voltage corresponding to the calculated overall luminance from a plurality of predetermined values of the pixel voltage, each of which has a corresponding luminance.

8. The method of claim 7, wherein adjusting the period of time comprises:
selecting a modulation signal based on the selected value of the pixel voltage from a plurality of modulation signals, each of which has a corresponding luminance.

9. The method of claim 8, wherein the image signal comprises a gradation value indicative of luminance of light to be emitted by the first pixel relative to luminance of light to be emitted by other pixels, and wherein selecting the modulation signal is further based on the gradation value.

10. The method of claim 8, wherein adjusting the period of time further comprises:
generating a clock signal; and
applying the selected modulation signal to the clock signal.

11. An electron emission display device programmed to conduct the method of claim 1.

12. An electron emission display device, comprising:
an array of pixels comprising a first pixel configured to emit light when a pixel voltage is applied thereto;
a processor configured to calculate overall luminance of a frame based on an image signal for the frame;
a voltage generator configured to adjust a pixel voltage of the first pixel based on the calculated overall luminance of the frame;
a data driver configured to provide a data signal to the array of pixels, the data driver being configured to adjust the period of time during which the first pixel is to be turned on based on the adjusted pixel voltage, the data driver being further configured to apply the adjusted pixel voltage to the first pixel during the adjusted period of time; and
a scan driver configured to provide a scan signal to the array of pixels.

13. The device of claim 12, wherein the image signal comprises a gradation value indicative of luminance of light to be emitted by the first pixel relative to luminance of light to be emitted by other pixels.

14. The device of claim 13, wherein the data driver is configured to maintain a gradation-to-luminance ratio substantially constant without regard to the adjusted the pixel voltage.

15. The device of claim 13, wherein the data driver comprises a lookup table comprising various values of the adjusted period of time, wherein each value of the adjusted time is provided for each gradation level and for each adjusted pixel voltage, and wherein the data driver is configured to adjust the period of time based on the lookup table.

16. The device of claim 15, wherein the lookup table comprises data for compensating non-linearity between the pixel voltage and the luminance of light emitted by the first pixel.

17. The device of claim 12, wherein the voltage generator is configured to adjust the pixel voltage as the higher the calculated overall luminance is, the smaller the pixel voltage is.

18. The device of claim 12, wherein the voltage generator comprises a lookup table comprising a plurality of predetermined values of the pixel voltage, each of which has a corresponding to luminance, and wherein the voltage generator is configured to select one of the predetermined values of the pixel voltage based on the calculated overall luminance.

19. The device of claim 18, wherein the data driver comprises a lookup table comprising a plurality of modulation signals, each of which has a corresponding value of the pixel voltage, and wherein the data driver is configured to select one of the plurality of modulation signals based on the selected value of pixel voltage.

20. The device of claim 19, wherein the data driver further comprises a clock generator for generating a clock signal, and wherein the data driver is configured to apply the selected one of the modulation signals to the clock signal.
